(19) United States
(12) Patent Application Publication
(10) Pub. No.: US 2011/0149003 A1
(43) Pub. Date: Jun. 23, 2011

(54) INK-JET PRINTER

(75) Inventor: Etsuyasu KONDO, Tama-shi (JP)

(73) Assignee: OLYMPUS CORPORATION, Tokyo (JP)

(21) Appl. No.: 12/971,278

(22) Filed: Dec. 17, 2010

(30) Foreign Application Priority Data
Dec. 22, 2009 (JP) 2009-291256

(51) Int. Cl. B41J 2/01

(52) U.S. Cl. 347/104

(57) ABSTRACT

An image recording apparatus includes first and second drums configured to transfer a recording medium, first and second recording sections arranged in opposition to the first and second drums, respectively, and each including a recording head configured to record an image on the recording medium, and a main body frame configured to rotatably support at least the first and second drums, and when replacement of the recording head is to be carried out, each of the first and second recording sections is moved in a direction perpendicular to an axial direction of a rotating shaft of corresponding one of the first and second drums, and in horizontal direction.

### CROSS-REFERENCE TO RELATED APPLICATIONS

This application is based upon and claims the benefit of priority from prior Japanese Patent Application No. 2009-291256, filed Dec. 22, 2009, the entire contents of which are incorporated herein by reference.

### BACKGROUND OF THE INVENTION

1. Field of the Invention

The present invention relates to an ink-jet printer in which a recording section provided with a recording head can be drawn out from an apparatus main body.

2. Description of the Related Art

In general, by reason of small noise at the recording time, and excellent print quality, ink-jet printers have become widespread. Ink-jet printers are roughly classified into two types. A first type is a serial type ink-jet printer configured to carry out recording on a recording medium while moving both an ink-jet head and the recording medium. A second type is a full-line type ink-jet printer (hereinafter referred to as a line printer) in which a line head is constituted by fixing one or a plurality of ink-jet heads to occupy a width greater than or equal to the width of a recording medium, and which is configured to carry out recording on the recording medium by moving only the recording medium.

Of these ink-jet printers, the line printer has a large recording speed, and can meet the requirements of the market demanding mass processing.

Incidentally, when an ink-jet head is clogged with foreign matter floating in the apparatus such as paper powder, dust, and the like, ink-discharge deterioration is caused. This makes it unable to obtain high picture quality.

In order to solve such a problem, many of ink-jet printers are provided with a cleaning mechanism for forcibly discharging ink to carry out cleaning by sucking ink from a nozzle of an ink-jet head or by pressurizing the ink-jet head. When the ink-discharge deterioration is not improved even by using the cleaning mechanism, or when the cleaning mechanism is not provided, the ink-jet head has to be replaced. At this time, the workability of ink-jet head replacement becomes important.

Particularly, in the line printer, it is difficult to secure the working space for replacement of the ink-jet head.

Thus, in, for example, Jpn. Pat. Appln. KOKAI Publication No. 2004-142365, an ink-jet recording apparatus including a line type recording head is disclosed. In this apparatus, a front frame, and rear frame are provided on either side of a recording medium transfer path. A rail is arranged between the front frame and rear frame, and a line head (head unit) is supported on the rail. Further, the head unit can be drawn out to the front of the apparatus main body along the rail. That is, the head unit is moved in a direction perpendicular to the recording medium transfer direction, and is drawn out to the outside of the apparatus main body.

### BRIEF SUMMARY OF THE INVENTION

According to an embodiment of the present invention, there is provided an ink-jet printer comprising: a drum configured to transfer a recording medium by holding the recording medium on a cylindrical outer circumferential surface thereof; a recording section arranged in opposition to the outer configured circumferential surface of the drum, and including a recording head configured to record an image on the recording medium; and a main body frame configured to rotatably support both ends of a rotating shaft of the drum, wherein when replacement work of the recording head is to be carried out, the recording section is drawn out with respect to the main body frame both in a direction perpendicular to an axial direction of the rotating shaft and in a direction perpendicular to a direction of gravitational force.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a transfer system of a recording medium in an image recording apparatus according to a first embodiment of the present invention.

FIG. 2 is a view schematically showing a recording apparatus main body viewed from a direction of an arrow A of the image recording apparatus of FIG. 1.

FIG. 3 is a view showing, in detail, a configuration example of a first recording section, first drum, and first cleaning section, and is a view showing a state where the first recording section is positioned in a printing position.

FIG. 4 is a view of the configuration example of the first recording section, first drum, and first cleaning section of FIG. 3 viewed from another direction.

FIG. 5 is a view for explaining a state of engagement of a guide member and guide shaft with each other, and is a view viewed from above the first recording section.

FIG. 6 is a view showing the state where the first recording section is raised along the guide shaft.

FIG. 7 is a view showing the state where the first recording section is being subjected to cleaning processing by the first cleaning section.

FIG. 8 is a view showing the state where the first recording section is moved to an upper limit position, and draw-out shafts are inserted.

FIG. 9 is a view of the state in FIG. 8 where the draw-out shafts are inserted viewed from another direction.

FIG. 10 is a view for explaining a first modification example of the first embodiment of the present invention, and is a view showing the state where a first recording section is in a printing position.

FIG. 11 is a view for explaining the first modification example of the first embodiment of the present invention, and is a view showing the state where the first recording section is positioned in an inclined position.

FIG. 12 is a view for explaining a second modification example of the first embodiment of the present invention, and is a view showing the state where a first recording section is positioned in an inclined position.

FIG. 13 is a view schematically showing a transfer system of a recording medium in an image recording apparatus according to a second embodiment of the present invention.

FIG. 14 is a view showing the state where a first recording section in the second embodiment of the present invention is positioned in a printing position.

FIG. 15 is a view showing the state where the first recording section in the second embodiment of the present invention is positioned in an inclined position.

FIG. 16 is a view for explaining a first modification example of the second embodiment of the present invention, and is a view showing the state where a first recording section is positioned in a printing position.

FIG. 17 is a view for explaining the first modification example of the second embodiment of the present invention, and is a view showing the state where the first recording section is positioned in an upper limit position.

FIG. 18 is a view for explaining the first modification example of the second embodiment of the present invention, and is a view showing the state where the first recording section is positioned in an inclined position.

### DETAILED DESCRIPTION OF THE INVENTION

Hereinafter, embodiments of the present invention will be described below in detail with reference to the drawings.

### First Embodiment

In the beginning, a first embodiment of the present invention will be described below.

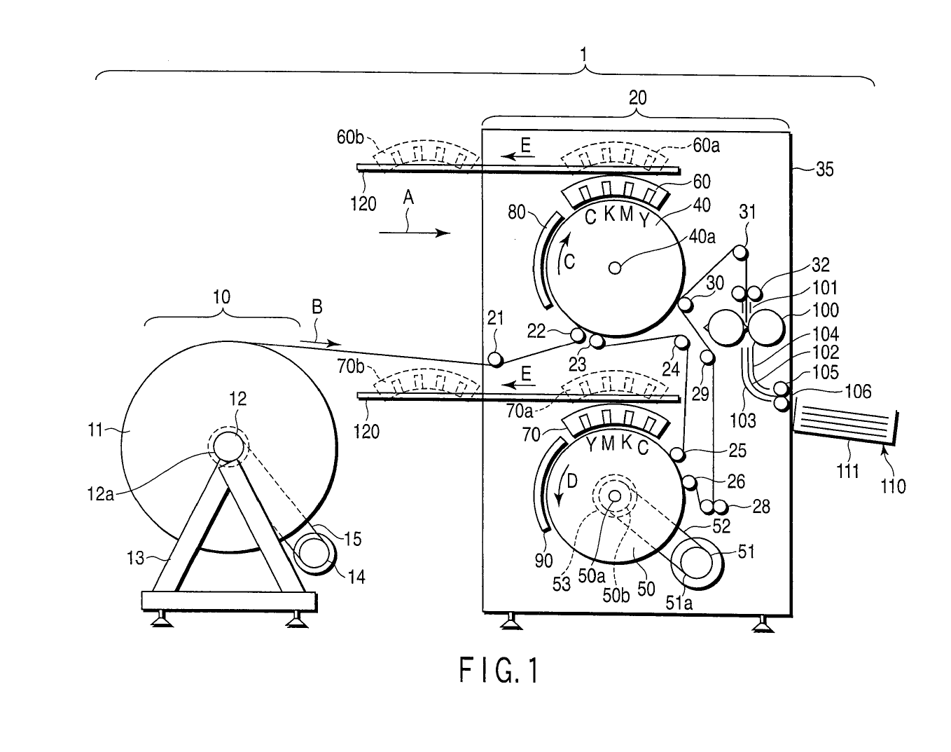

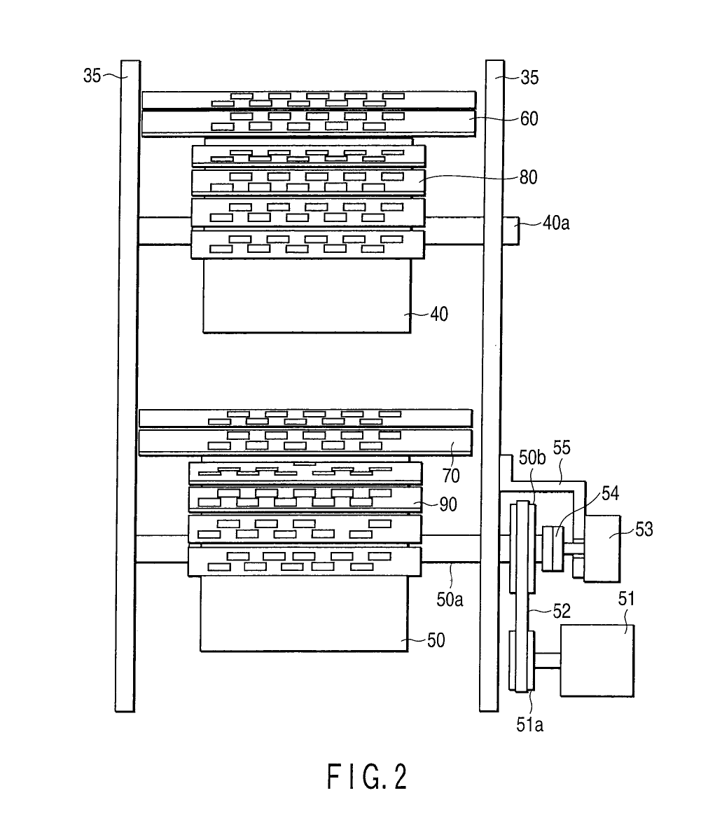

FIG. 1 is a view schematically showing a transfer system of a recording medium 11 in an image recording apparatus 1 according to the first embodiment of the present invention. FIG. 2 is a view schematically showing a recording apparatus main body viewed from a direction of an arrow A of the image recording apparatus 1 of FIG. 1.

The image recording apparatus 1 in this embodiment is roughly constituted of a paper feed section 10, main body section 20, and ejection section 110.

First, the configuration of the paper feed section 10 which becomes a recording medium supply section shown in FIG. 1 will be described below.

This paper feed section 10 is constituted by including a paper tube fixing shaft 12, stand 13, and brake 14.

The paper tube fixing shaft 12 retains a recording medium 11 by penetrating a center of the long recording medium 11 wound into a roll-shape. The stand 13 is used to rotatably support the paper tube fixing shaft 12. The brake 14 is configured to adjust the unwound state of the recording medium 11 as the need arises.

For more detail, the paper tube fixing shaft 12 is provided with a plurality of claw sections (not shown) which are protruded in the radial direction by pouring air from an air injection port (not shown). The claw sections are dug into the paper tube of the recording medium 11. As a result of this, the recording medium 11 is firmly held by the paper tube fixing shaft 12.

Further, the brake 14 is coupled to the paper tube fixing shaft 12 through a belt 15. The brake 14 gives tension in a direction opposite to the transfer direction to the recording medium 11. Furthermore, the paper tube fixing shaft 12 is provided with an angular velocity detection sensor (not shown). By an output signal of the angular velocity detection sensor, the brake 14 is controlled, and the tension of the recording medium 11 is also controlled.

By the configuration described above, the recording medium 11 is rotated together with the paper tube fixing shaft 12, and is drawn out to be supplied to the main body section 20. As the recording medium 11, for example, rolled paper (continuous medium) or the like is used. It should be noted that the recording medium 11 may be a medium other than rolled paper, such as long continuous fan-fold paper, or may also be a cut sheet cut into a predetermined size.

Next, the configuration of the main body section 20 will be described below with reference to FIGS. 1 and 2.

The main body section 20 is constituted of a transfer system (drum transfer section) constituted of a plurality of free rollers 21, 22, 23, 24, 25, 26, 29, 30, and 31 which are transfer rollers, nip roller pairs 28 and 32, first drum 40, second drum 50, the transfer system being the transfer means of the recording medium 11, main body frame 35, first recording section 60, second recording section 70, first cleaning section 80, second cleaning section 90, and cutter section 100.

The first drum 40 and second drum 50 are arranged in such a manner that at least part of each of the drums 40 and 50 overlap each other in the direction of gravitational force. Further, the first recording section 60 and second recording section 70 are arranged in opposition to the first drum 40, and second drum 50, respectively. Furthermore, the first cleaning section 80 and second cleaning section 90 are arranged in the vicinities of the first recording section 60, and second recording section 70, respectively.

The cutter section 100 is configured to cut the recording medium 11 to a predetermined length.

The main body frame 35 includes a front frame, and rear frame on both sides in a direction perpendicular to the transfer direction of the first drum 40 and second drum 50. In other words, the main body frame 35 is constituted of two (front and rear) metallic plates configured to rotatably supports the first drum 40 and second drum 50 at their both ends, and arranged in such a manner that the first drum 40 and second drum 50 are interposed between them. It should be noted that the main body frame 35 supports at least the first drum 40, second drum 50, and a head retaining member 62.

The main body section 20 introduces thereinto the recording medium 11 sent out from the paper feed section 10 described previously in the direction of an arrow B (see FIG. 1). Further, the recording medium 11 brought into the main body section 20 is transferred to the first drum 40 via the free rollers 21 and 22. Each of these free rollers 21 and 22 is rotatably supported by the main body frame 35.

The recording medium 11 transferred to the first drum 40 is wound around the first drum 40 on an outer circumferential surface of the first drum 40 which is a transfer surface thereof by the free rollers 22 and 23 over a winding angle of 330 degrees. The first drum 40 is constituted of a hollow cylinder made of, for example, aluminum. A rotating shaft 40a of the first drum 40 is rotatably supported by the main body frame 35. Further, one end of a member configured to support the first cleaning section 80 is engaged with the rotating shaft 40a.

The first drum 40 is rotated by the recording medium 11 in the clockwise direction (direction C indicated by an arrow shown in FIG. 1) as shown in FIG. 1. As a result of this, the recording medium 11 is transferred to a position immediately under the first recording section 60 arranged in opposition to the first drum 40. Further, the first recording section 60 jets out ink to record an image on the surface of the recording medium 11.

The winding angle 330 degrees of the recording medium 11 on the first drum 40 is set in accordance with the following contents. That is, when it is assumed that tension on the winding start side is T1, the tension on the winding end side of the first drum is T2, coefficient of static friction between the first drum 40 and recording medium 11 is μ, and winding angle is θ, each value is set in such a manner that the following relationship is established.

T2/T1≦exp(μθ)

For example, when T1 is 35N, and T2 is 50N, considering that the recording medium should not slip on the first drum 40 even when the coefficient μ of static friction of the recording medium is 0.07, θ is set at 330 degrees. In the second drum 50 to be described later, setting is carried out in the similar way.

As a result of this, slippage between the first drum 40 and recording medium 11 is eliminated, further it is possible to make the recording medium 11 in close contact with the first drum 40, and it becomes possible to carry out accurate sheet transfer, and rotational speed control.

The recording medium 11 on the surface of which an image has been recorded by the first recording section 60 is subsequently separated from the first drum 40 by the free roller 23. Further, the recording medium 11 is wound around the second drum 50 from the free roller 25 via the free roller 24 on an outer circumferential surface of the second drum 50 which is a transfer surface thereof. At this time, the recording medium 11 is wound around the second drum 50 on the outer circumferential surface (transfer surface) thereof with the surface (surface on which an image has already been recorded) of the recording medium 11 in close contact with the outer circumferential surface. This recording medium 11 is wound around the second drum 50 by the free rollers 25 and 26 over a winding angle of, for example, 330 degrees like in the case of the first drum 40. As a result of this, the recording medium 11 causes no slippage with respect to the outer circumferential surface of the second drum 50, and is held thereon in close contact therewith like in the case of the first drum 40.

Further, the second drum 50 is, like the first drum 40, constituted of a hollow cylinder made of, for example, aluminum. It should be noted that the free rollers 23, 24, and 25 are also rotatably supported by the main body frame 35.

A rotating shaft 50a of the second drum 50 is rotatably supported by the main body frame 35. Further, the rotating shaft 50a is coupled to a drive motor 51 through a pulley 50b, and belt 52. The drive motor 51 rotates the second drum 50 in the counterclockwise direction (direction indicated by an arrow D shown in FIG. 1) shown in FIG. 1. As a result of this, the recording medium 11 is transferred to a position immediately under the second recording section 70 arranged in opposition to the second drum 50. Further, the second recording section 70 jets out ink to record an image on the back surface of the recording medium 11. As a result of this, two-sided recording on the recording medium 11 is completed.

It should be noted that the second drum 50 serves as a drive drum, and first drum 40 is a driven drum to be rotated by the second drum 50 through the recording medium 11.

As shown in FIG. 2, to the rotating shaft 50a of the second drum 50, an encoder 53 serving as a position detection section is coupled through a coupling 54. This encoder 53 is fixed to one end of a fixing member 55 having a substantially L-shaped cross section. The other end of the fixing member is fixed to the main body frame 35.

The encoder 53 is rotated concomitantly with the rotation of the second drum 50, and outputs a detection pulse corresponding to the rotational position of the second drum 50. Further, the detection pulse output from the encoder 53 is input to a drive circuit board (not shown) configured to drive recording heads of the first recording section 60 and second recording section 70. The drive circuit board controls drive of the recording heads on the basis of the detection pulse.

That is, the recording medium 11 is transferred at the same speed without slipping on the first drum 40 and second drum 50, and hence it is possible to control the jet drive of the first recording section 60 and second recording section 70 on the basis of the detection pulse to be output concomitantly with the rotation of the second drum 50. It should be noted that one end of a member configured to support the second cleaning section 90 is engaged with the rotating shaft 50a.

Next, the configurations of the first recording section 60, and second recording section 70 will be described below.

It should be noted that in this embodiment, the first recording section 60 and second recording section 70 have the configurations equivalent to each other, and hence the first recording section 60 will be representatively described as an example.

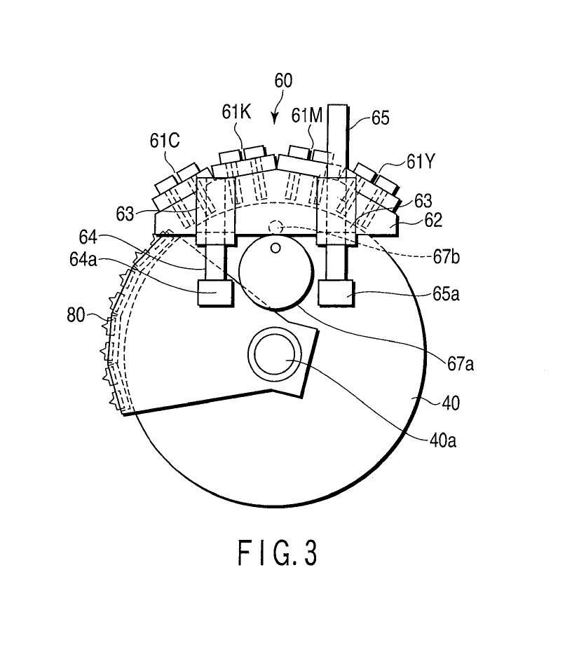

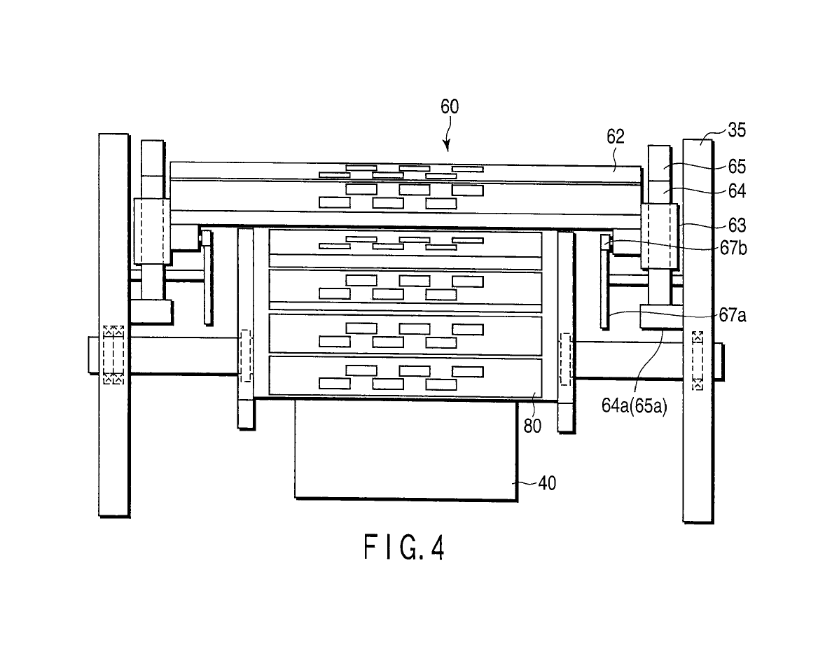

FIGS. 3 and 4 show the configurations of the first recording section 60, first drum 40, and first cleaning section 80 in detail, FIG. 3 is a view of a case where the first recording section 60 is in a recording position (printing position) with respect to the first drum 40, and FIG. 4 is a view showing FIG. 3 viewed from another direction. FIG. 5 is a view for explaining a state of engagement of a guide member 63 and guide shaft 64, 65 with each other, and is a view viewed from above the first recording section 60.

As shown in FIG. 3, the first recording section 60 includes head sections 61C, 61K, 61M, and 61Y configured to jet out ink of a total of four colors of, for example, cyan (C), black (K), magenta (M), and yellow (Y), head retaining member 62 configured to retain the head sections 61C, 61K, 61M, and 61Y, and guide members 63.

As the head sections 61C, 61K, 61M, and 61Y of this embodiment, a plurality of short recording heads each having a length shorter than the width of the recording medium 11 are used. Further, these recording heads are arranged in a staggered form in a direction perpendicular to the transfer direction of the recording medium 11, whereby a line head having a width greater than or equal to the recording area width of the recording medium 11 is constituted.

For that purpose, as shown in FIG. 5, the head retaining member 62 is provided with a plurality of openings through which the recording head can be inserted. The recording head inserted through the opening is fixed to the head retaining member 62.

Further, a total of four guide members 63 serving as engagement members are provided on both side surfaces of the head retaining member 62 in the front-back direction of the apparatus, i.e., in the direction perpendicular to the transfer direction of the recording medium 11. The guide member 63 includes an opening (groove) on the paper ejection side on which the ejection section 110 is arranged as shown in FIG. 5. In this embodiment, although the guide member 63 has a squared U-shape, the guide member 63 may also have a V-shape. Further, the guide member 63 is engaged with a guide shaft 64 or 65 upwardly extending in the direction of gravitational force. One end of the guide shaft 64, 65 is fixed to corresponding one of four guide shaft fixing members 64a and 65a provided inside the main body frame 35.

It should be noted that lengths of the two guide shafts 64 arranged on the paper feed side are made shorter than the lengths of the two guide shafts 65 arranged on the paper ejection side.

As described above, the guide member 63 to be engaged with the guide shaft 64 or 65 has the U-shape, and hence the guide member 63 is configured to be movable in the axial direction of the guide shaft 64, 65, and to be movable toward the paper feed side (direction indicated by an arrow E in FIG. 5) on which the paper feed section 10 is arranged with respect to the guide shaft 64, 65. That is, the first recording section 60 is configured to be movable in the axial direction of the guide shaft 64, 65, and in the direction to the paper feed side. It should be noted that although not shown, the guide member 63 is provided with a leaf spring, plunger or the like, and is configured in such a manner that no play occurs between the guide member 63 and guide shaft 64 or 65 when the guide member 63 and guide shaft 64 or 65 are engaged with each other.

Next, the first cleaning section 80, and second cleaning section 90 will be described below.

Here, the first cleaning section 80, and second cleaning section 90 have the same configuration, and hence the first cleaning section 80 will be representatively described as an example.

As shown in FIGS. 3 and 4, the first cleaning section 80 configured to prevent each recording head of the head sections 61C, 61K, 61M, and 61Y from being clogged is arranged in the vicinity of the first recording section 60. The first cleaning section 80 is constituted of known mechanisms such as a wipe blade, nozzle suction mechanism, and the like.

FIG. 3 shows a state where an image is recorded. In this state, the first cleaning section 80 is retracted to the vicinity of the first recording section 60.

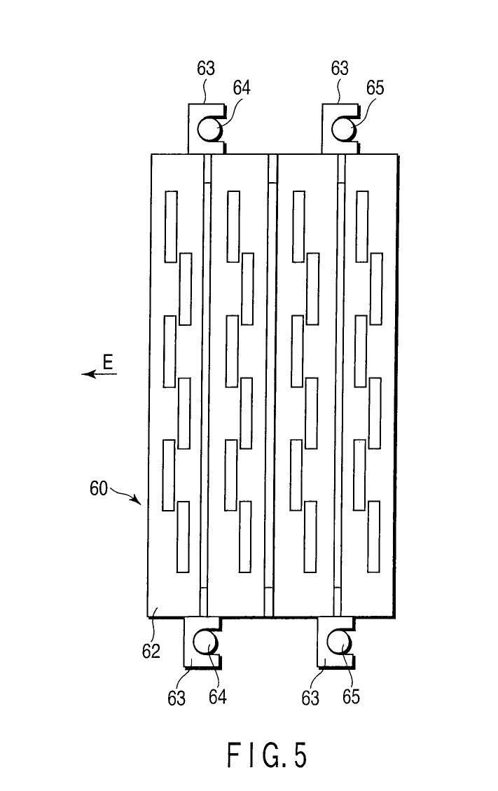

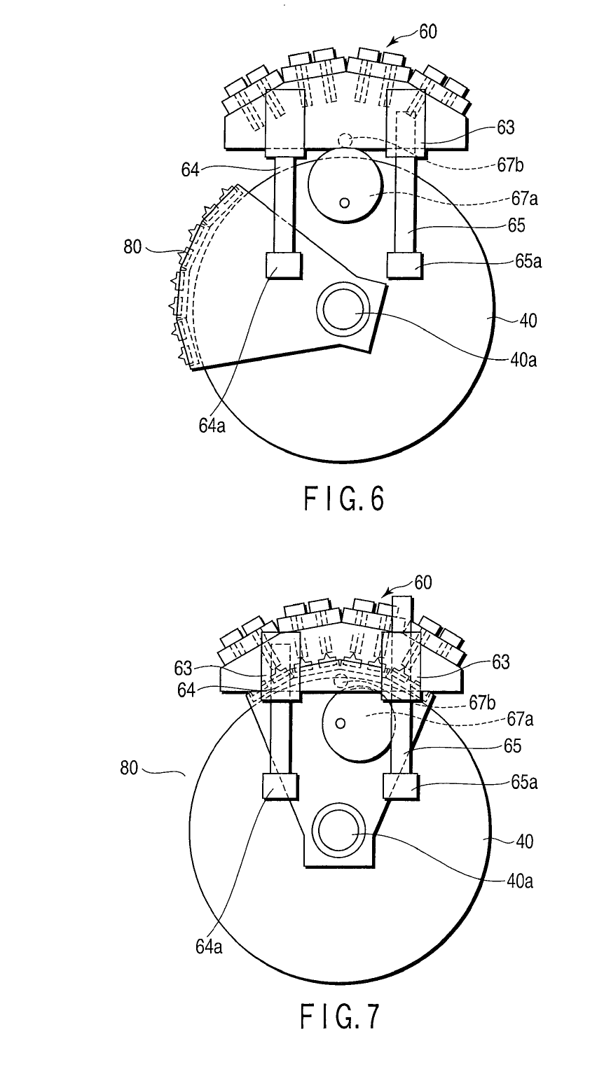

When cleaning is to be executed, first, the first recording section 60 is moved from the state shown in FIG. 3 to the state shown in FIG. 6. That is, the first recording section 60 is raised in the radial direction to be separated from the first drum 40, whereby a space into which the first cleaning section 80 is to be inserted is produced. At this time, the head retaining member 62 is raised in the axial direction of the guide shafts 64 and 65 by the guide members 63 (see FIG. 6).

Further, at the point at which the space is produced, the first cleaning section 80 is rotated around the rotating shaft 40a of the first drum 40 in the clockwise direction to a position immediately under the first recording section 60. Further, the first recording section 60 is moved from the state shown in FIG. 6 to the state shown in FIG. 7, and cleaning processing of each recording head is carried out.

After the cleaning processing is completed, the first cleaning section 80 is rotated from the cleaning position around the rotating shaft 40a of the first drum 40 in the order reverse to the operation order described previously to move to the retraction position shown in FIG. 3.

In the manner described previously, the recording medium 11 on either side of which an image has been recorded by the first recording section 60 and second recording section 70 reaches the second nip roller pair 32 from the free roller 26 via the first nip roller pair 28, free rollers 29, 30, and 31. Furthermore, the recording medium 11 is transferred to the cutter section 100 from the second nip roller pair 32 via an introduction guide 101. A drive motor (not shown) is coupled to the first nip roller pair 28, and second nip roller pair 32. Further, the first nip roller pair 28, and second nip roller pair 32 are controlled in such a manner that the speed of the outer circumferential surface of each of the roller pairs 28 and 32 is equal to the transfer speed of the recording medium 11 transferred from the second drum 50. It should be noted that the free roller 26, first nip roller pair 28, second nip roller pair 32, free rollers 29, 30, and 31 are rotatably supported by the main body frame 35.

The cutter section 100 cuts the recording medium 11 transferred thereto to a predetermined length (hereinafter the cut recording medium is referred to as a cut sheet 102). Further, the cut sheet 102 is guided to ejection guides 103 and 104, and is then ejected to a storage tray 111 serving as an ejection section 110 via an ejection roller pair 106.

Next, a movement mechanism for movement of each of the first recording section 60 and second recording section 70 with respect to each of the first drum 40, and second drum 50, respectively will be described below with reference to FIGS. 3 to 7.

It should be noted that here, the first recording section 60 and second recording section 70 are identical in configuration, and hence the first recording section 60 will be representatively described below.

As shown in FIGS. 3 and 4, the movement mechanism includes a cam 67a, and cam follower 67b. The cam 67a is rotatably attached to the inside of each of the front part and rear part of the main body frame 35. The cam follower 67b is provided on the head retaining member 62 of the first recording section 60.

Further, the motion of bringing the first recording section 60 to be spaced or vicinity to the first drum 40 along the guide shafts 64 and 65 is carried out by rotating the cam 67a by means of a drive source (not shown). That is, by rotating the cam 67a while making the circumferential surface of the cam 67a, and circumferential surface of the cam follower 67b in contact with each other, the first recording section 60 is brought to be spaced or vicinity to the first drum 40.

By the motion described above, the first recording section 60 moves, with respect to the first drum 40, to the printing position (see FIG. 3) at which image recording is to be carried out, upper limit position (see FIG. 6) at which the first cleaning section 80 can be inserted between the first recording section 60 and first drum 40, and cleaning position (see FIG. 7) at which the cleaning operation for the first recording section 60 is carried out by the first cleaning section 80.

Next, the procedure for the work of replacing the recording head will be described below with reference to FIGS. 1 to 9. It should be noted that here the first recording section 60 and second recording section 70 are identical in the work procedure, and hence the procedure for the work of replacing the recording head at the head section 61 of the first recording section 60 will be representatively described below.

First, as shown in FIG. 3, when the first recording section 60 is in the printing position at which the first recording section 60 carries out image recording with respect to the first drum 40, the apparatus is operated to move the first recording section 60 to the upper limit position shown in FIG. 6. That is, by rotating the cam 67a, the position of the first recording section 60 is moved from the printing position shown in FIG. 3 to the upper limit position shown in FIG. 6. The engagement state of the guide shafts 64 and 65, and guide members 63 at the upper limit position is a state where the guide shaft 65 and guide member 63 are engaged with each other, and guide shaft 64 and guide member 63 are not engaged with each other. The engagement state at the upper limit position is made as described above in order that, when the first recording section 60 is drawn out to the paper feed side as will be described later, the guide member 63 on the paper ejection side can be passed without an interference between an upper end of the guide shaft 64 and guide member 63 on the paper ejection side.

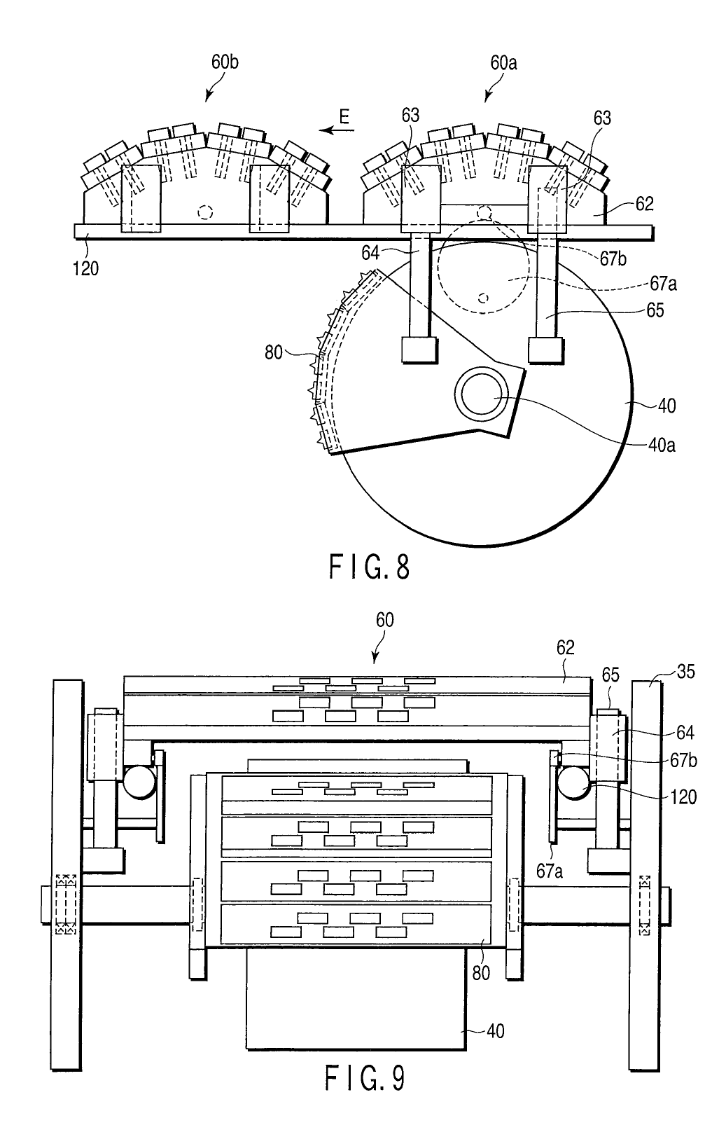

FIGS. 8 and 9 are views schematically showing the first recording section 60, first drum 40, and first cleaning section 80 at the time at which the first recording section 60 is moved to the upper limit position, and draw-out shafts 120 are inserted. It should be noted that hereinafter when the first recording section 60 is positioned in the upper limit position, it is referred to as the first recording section 60a, and when the first recording section 60 is positioned in the draw-out position (head replacement position), it is referred to as the first recording section 60b.

When the first recording section 60 is in the state of the first recording section 60a in the upper limit position, a side outer cover (not shown) on the paper feed side of the main body section 20 is opened. Further, the two draw-out shafts 120 serving as jigs (shaft members) for the maintenance work are inserted into the main body section 20 from the paper feed side. The draw-out shafts 120 are supported by the main body frame 35 by means of draw-out shaft support members (not shown) provided at four positions on the paper feed side in the main body frame 35, and on the paper ejection side. As a result of this, the first recording section 60 in the upper limit position is supported by the two draw-out shafts 120.

It should be noted that in this embodiment, although it has been described that the draw-out shafts 120 are inserted into the main body section 20 at the time of the work as jigs for the maintenance work, the draw-out shaft is not limited to this. For example, the draw-out shaft 120 may be constituted of a telescopic slide rail or the like, and may be provided by being previously stored inside the main body section 20.

Then, the first recording section 60a moved to the upper limit position is further moved to the paper feed side indicated by an arrow E in FIG. 1 or FIG. 8 while being slid along the draw-out shafts 120 in a state where the section 60a is supported on the shafts 120. In other words, the first recording section 60a moved to the upper limit position is further moved in the direction perpendicular to the axial direction of the rotating shaft 40a of the first drum 40, and in horizontal direction (direction perpendicular to the direction of gravitational force). This brings the first recording section 60 into the state of the first recording section 60b in the draw-out position (head replacement position). At this time, as described previously, the length of the guide shaft 64 is shorter than the guide shaft 65. As a result, when the first recording section 60a moved to the upper limit position is drawn out to the paper feed side, occurrence of an interference between the upper end of the guide shaft 64 and guide member 63 on the paper ejection side is eliminated.

It should be noted that as shown in FIG. 1, the first recording section 60b in the draw-out position is drawn out to the outside of the main body section 20 (main body frame 35). Needless to say, part of the first recording section 60b may also be kept inside the main body section 20 (main body frame 35).

In the state of the first recording section 60b in the draw-out position, the replacement work of the recording head is carried out. After the work is completed, the first recording section 60b in the draw-out position is moved toward the paper ejection side to the state of the first recording section 60a in the upper limit position while being slid on the draw-out shafts 120. At this time, when the first recording section 60b is moved until the guide member 63 collides against the guide shaft 65, it can be said that the first recording section 60 has been moved to the state of the first recording section 60a in the upper limit position.

Then, the draw-out shafts 120 in the inserted state are drawn out (taken out) from the inside of the main body section 20 to the paper feed side. As a result, the first recording section 60a in the upper limit position is then supported by the cams 67a through the cam followers 67b. Thereafter, the apparatus is operated, and the cam 67a is rotated, whereby the first recording section 60a in the upper limit position is moved to the printing position shown in FIG. 3 to be restored to the state where the first recording section can carry out the normal printing operation.

Thereafter, a cleaning operation is carried out in order to fill the inside of the new replacement recording head with ink. After this, a test pattern is printed to confirm presence/absence of defective ink jetting, and image adjustment such as position adjustment of the recording head, print density adjustment, and the like is carried out, thereby completing a series of recording head replacement work.

It should be noted that in this embodiment, although the description has been given assuming that the first recording section 60 is drawn out to the paper feed side, the embodiment is not limited to this. For example, when the lengths of the two guide shafts 64 arranged on the paper feed side are made longer than the lengths of the two guide shafts 65 arranged on the paper ejection side, and guide members 63 are made to open toward the paper feed side, it is possible to draw out the first recording section 60 to the paper ejection side.

Further, when the second recording section 70 is drawn out, and the replacement work of the recording head is to be carried out, if the recording medium 11 is obstructive of the work, it is advisable to temporarily cut the recording medium 11 at a position between the paper feed section 10 and paper feed side of the main body section 20 to carry out the work.

Further, in this embodiment, although the paper feed section 10 is to be spaced the main body section 20 in consideration of the space for the maintenance work, the paper feed section 10 may be made close to the main body section 20 at the time of normal use, and the paper feed section 10 may be moved to be separated from the main body section 20 at the time of maintenance work.

Further, in this embodiment, although the guide member 63 has a U-shape opening toward the paper ejection side on which the ejection section 110 is arranged, the guide member 63 is not limited to this. For example, the guide member to be engaged with the guide shaft 64 having the shorter length may have an annular shape, and the guide shaft 64 may be inserted into the inside of the annular part.

Further, in this embodiment, although the first drum 40, and second drum 50 are used as part of the transfer means, the transfer means is not limited to the above. For example, belt transfer in which the recording medium is attracted to a belt to be transferred may also be employed. In this case too, the recording section is moved in a direction perpendicular to an axial direction of rollers spanned by a belt, and in horizontal direction (direction perpendicular to the direction of the gravitational force).

As described above, in this first embodiment, there is no need to provide the main body frame 35 with an opening used to draw out the recording section therethrough.

### First Modification Example of First Embodiment

Next, a first modification example of the first embodiment of the present invention will be described below.

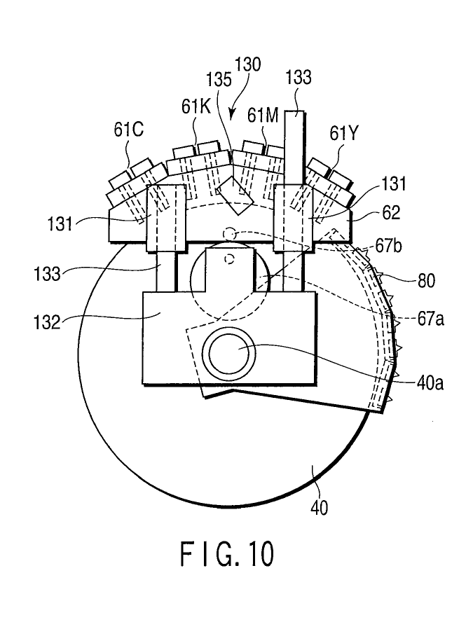

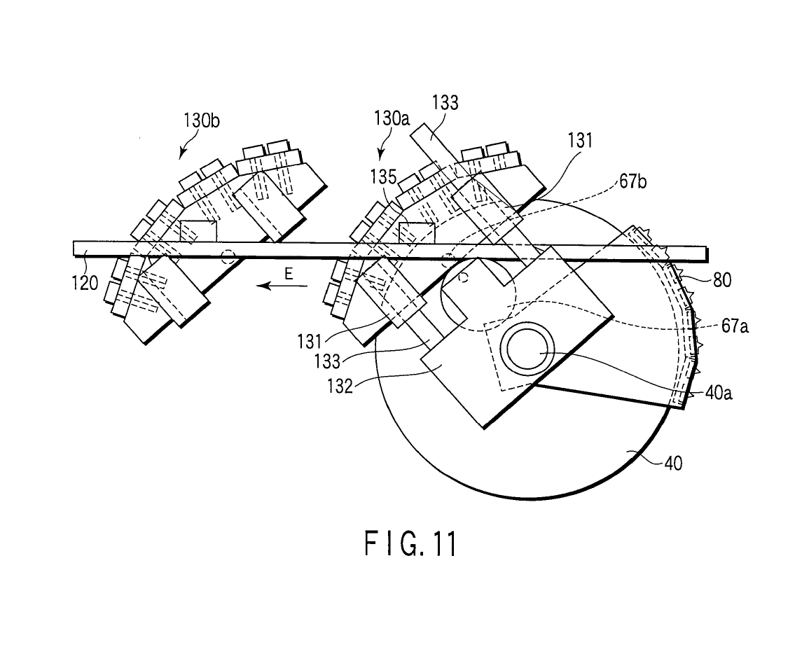

FIGS. 10 and 11 are views for explaining the first modification example of the first embodiment of the present invention, FIG. 10 is a view showing the state where a first recording section 130 is in a printing position, and FIG. 11 is a view showing the state where the first recording section 130 is in an inclined position.

Four guide members 131 are fixed to both side surfaces of a head retaining member 62 of the first recording section 130 in the front-back direction of the apparatus. These guide members 131 are engaged with four guide shafts 133 extending in the radial direction of a first drum 40. One end of each of the guide shafts 133 is held by a guide shaft fixing member 132. Further, lengths of the two guide shafts 133 arranged on the paper feed side are made shorter than the lengths of the two guide shafts 133 arranged on the paper ejection side.

It should be noted that the guide member 131 of the first modification example of this embodiment also has a squared U-shape having an opening on the paper ejection side like in the first embodiment described previously. Further, the guide member 131 is configured to be movable in the axial direction of the guide shaft 133, and attachable/detachable to/from the guide shaft 133 on the paper feed side. Further, the guide member 131 is provided with, although not shown, a leaf spring, plunger or the like, and is configured in such a manner that no play occurs between the guide member 131 and guide shaft 133 when the guide member 131 and guide shaft 133 are engaged with each other.

The guide shaft fixing member 132 is engaged with a rotating shaft 40a of the first drum 40, and is held rotatable around the rotating shaft 40a of the first drum 40. As a result of this, the first recording section 130 is held by a main body frame 35 through the guide shafts 133, guide shaft fixing members 132, and rotating shaft 40a of the first drum 40.

Further, draw-out guide members 135 to be brought into contact with the draw-out shafts 120 at the time of draw-out work for the first recording section 130 to be described later are provided on both the side surfaces of the head retaining member 62 of the first recording section 130 in the front-back direction of the apparatus. A movement mechanism configured to separate the first recording section 130 from the first drum 40 along the guide shafts 133 includes a cam 67a rotatably attached to the inner side of each of the guide shaft fixing members 132, and cam followers 67b attached to the head retaining member 62 of the first recording section 130. The operation of the movement mechanism is identical with the first embodiment described previously.

By means of this movement mechanism, the first recording section 130 moves, with respect to the first drum 40, to the printing position at which image recording is to be carried out, upper limit position at which a first cleaning section 80 can be inserted between the first recording section 130 and first drum 40, and cleaning position at which a cleaning operation is carried out by the first cleaning section 80.

Next, the procedure for the work of replacing the recording head in the first modification example of the first embodiment will be described below with reference to FIGS. 10 and 11.

First, as shown in FIG. 10, the first recording section 130 in the printing position with respect to the first drum 40 is rotated by a rotation mechanism (not shown) toward the paper feed side on which the first cleaning section 80 is not arranged by about 45 degrees as shown in FIG. 11. That is, the rotation mechanism rotates the first recording section 130 without changing the distance between the first recording section 130 and outer circumferential surface of the first drum 40 by using the rotating shaft 40a of the first drum 40 as a point of reference. As described above, in this modification example, the first recording section 130 is rotated along the circumferential surface of the first drum 40 without raising the first recording section 130. As a result, the first recording section 130 is brought into the state of the first recording section 130a in the inclined position.

In the state of the first recording section 130a in the inclined position, a side outer cover (not shown) on the paper feed side of the main body section 20 is opened. Further, two draw-out shafts 120 are inserted into the inside of the main body section 20 from the paper feed side. As a result of this, the first recording section 130a in the inclined position is supported by the two draw-out shafts 120 by means of the draw-out guide members 135.

Further, although not shown, the draw-out shafts 120 are supported by the main body frame 35 by means of draw-out shaft support members provided at four positions on the paper feed side, and paper ejection side in the main body frame 35.

Then, in the state where the first recording section 130a in the inclined position is supported by the draw-out shafts 120, the first recording section 130a in the inclined position is moved to the paper feed side while being slid on the draw-out shafts 120. In other words, the first recording section 130a moved to the inclined position is further moved in the direction perpendicular to the axial direction of the rotating shaft 40a of the first drum 40, and in horizontal direction. This brings the first recording section 130 into the state of the first recording section 130b in the draw-out position (head replacement position). At this time, the first recording section 130b in the draw-out position can be drawn out to the outside of the main body section 20 (main body frame 35). It should be noted that part of the first recording section 130b in the draw-out position may be kept inside the main body section 20 (main body frame 35).

In the state of the first recording section 130b in the draw-out position, the replacement work of the recording head is carried out. Further, after the work is completed, the first recording section 130b in the draw-out position is moved toward the paper ejection side to the state of the first recording section 130a in the inclined position while being slid on the draw-out shafts 120. At this time, when the first recording section 130b is moved until the guide member 131 collides against the guide shaft 133, it can be said that the first recording section 130b has been moved to the state of the first recording section 130a in the inclined position.

Then, the draw-out shafts 120 in the inserted state are drawn out from the inside of the main body section 20 to the paper feed side. Thereafter, the first recording section 130a in the inclined position is rotated to be moved to the printing position by the rotation mechanism (not shown), and is restored to the state where the first recording section can carry out the normal printing operation.

Thereafter, a cleaning operation is carried out in order to fill the inside of the new replacement recording head with ink, then a test pattern is printed to confirm presence/absence of defective ink jetting, and image adjustment such as position adjustment of the recording head, print density adjustment, and the like is carried out, thereby completing a series of recording head replacement work.

It should be noted that in the first modification example of this embodiment, when the first cleaning section 80 is arranged on the paper feed side, lengths of the two guide shafts 133 arranged on the paper feed side are made longer than the two guide shafts 133 arranged on the paper ejection side, and guide members 131 are made to open toward the paper feed side, it is possible to draw out the first recording section 130b to the paper ejection side.

### Second Modification Example of First Embodiment

Next, a second modification example of the first embodiment of the present invention will be described below.

In the second modification example of the first embodiment, a first recording section 140 is rotated by a rotation mechanism (not shown) around a rotating shaft 40a of a first drum 40 to the paper feed side on which a first cleaning section 80 is not arranged by about 45 degrees, and this position is made a printing position.

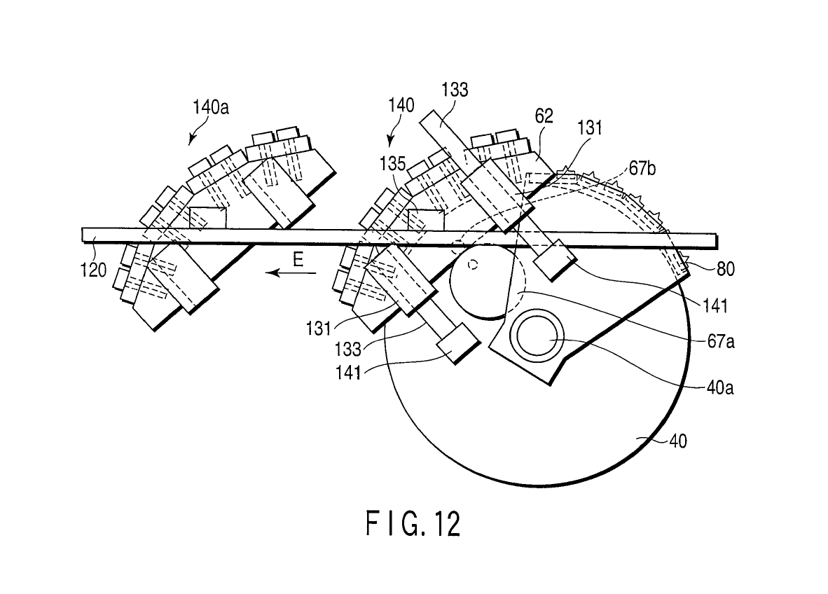

As shown in FIG. 12, four guide members 131 are fixed to both side surfaces of a head retaining member 62 of the first recording section 140 in the front-back direction of the apparatus. These guide members 131 are engaged with four guide shafts 133 extending in the radial direction of the first drum 40. One end of each of the guide shafts 133 is fixed to corresponding one of four guide shaft fixing members 141 provided inside the main body frame 35.

The guide member 131 of the second modification example of the first embodiment is also formed into a squared U-shape opening toward the paper ejection side like in the first embodiment described previously. Further, the guide member 131 is configured to be movable in the axial direction of the guide shaft 133, and attachable/detachable to/from the guide shaft 133 on the paper feed side. Further, the state of engagement of the guide shaft 133 and guide member 131 with each other is maintained by a leaf spring (not shown) or a plunger (not shown). It should be noted that lengths of the two guide shafts 133 arranged on the paper feed side are made shorter than the two guide shafts 133 arranged on the paper ejection side.

Further, draw-out guide members 135 to be brought into contact with the draw-out shafts 120 at the time of draw-out work for the first recording section 140 to be described later are provided on both the side surfaces of the head retaining member 62 of the first recording section 140 in the front-back direction of the apparatus. A movement mechanism configured to separate the first recording section 140 from the first drum 40 along the guide shafts 133 includes disk eccentric cams 67a rotatably attached to the inner side of the main body frame 35, and cam followers 67b attached to the head retaining member 62 of the first recording section 140. The operation of the movement mechanism is identical with the first embodiment described previously.

By means of this movement mechanism, the first recording section 140 can move, with respect to the first drum 40, to the printing position at which image recording is to be carried out, upper limit position at which a first cleaning section 80 can be inserted between the first recording section 140 and first drum 40, and cleaning position at which a cleaning operation is carried out by the first cleaning section 80.

Next, the procedure for the work of replacing the recording head according to the second modification example of the first embodiment of the present invention will be described below with reference to FIG. 12.

First, in the state of the first recording section 140 in the printing position, a side outer cover (not shown) on the paper feed side of the main body section 20 is opened. Further, two draw-out shafts 120 are inserted into the inside of the apparatus from the paper feed side. As a result of this, the first recording section 140 in the printing position is supported by the two draw-out shafts 120 by means of the draw-out guide members 135.

Further, although not shown, the draw-out shafts 120 are supported by the main body frame 35 by means of draw-out shaft support members provided at four positions on the paper feed side, and paper ejection side in the main body frame 35.

Then, in the state where the first recording section 140 in the printing position is supported by the draw-out shafts 120, the first recording section 140 is moved to the paper feed side while being slid on the draw-out shafts 120. In other words, the first recording section 140 in the printing position is further moved in the direction perpendicular to the axial direction of the rotating shaft 40a of the first drum 40, and in horizontal direction. This brings the first recording section 140 into the state of the first recording section 140a in the draw-out position (head replacement position). At this time, the first recording section 140a in the draw-out position can be drawn out to the outside of the main body section 20 (main body frame 35). It should be noted that part of the first recording section 140a in the draw-out position may be kept inside the main body section 20 in consideration of the space for the replacement work of the recording head.

In the state of the first recording section 140a in the draw-out position, the replacement work of the recording head is carried out. After the work is completed, the first recording section 140a in the draw-out position is moved toward the paper ejection side to the state of the first recording section 140 in the printing position while being slid on the draw-out shafts 120. At this time, when the first recording section 140a is moved until the guide member 131 collides against the guide shaft 133, it can be said that the first recording section 140a has been moved to the state of the first recording section 140 in the printing position.

Then, the draw-out shafts 120 in the inserted state are drawn out from the inside of the main body section 20 to the paper feed side. Thereafter, a cleaning operation is carried out in order to fill the inside of the new replacement recording head with ink, then a test pattern is printed to confirm presence/absence of defective ink jetting, and image adjustment such as position adjustment of the recording head, print density adjustment, and the like is carried out, thereby completing a series of recording head replacement work.

It should be noted that in the second modification example of this embodiment, when the first cleaning section 80 is arranged on the paper feed side, printing position of the first recording section 140 is arranged on the paper ejection side, lengths of the two guide shafts 133 arranged on the paper feed side are made longer than the two guide shafts 133 arranged on the paper ejection side, and guide members 131 are made to open toward the paper feed side, it is possible to draw out the first recording section 140a to the paper ejection side.

As described above, in the second modification example of the first embodiment, by inclining the printing position of the recording section in advance to the draw-out side, it is possible to draw out the recording section without moving the recording section, and carry out the work efficiently.

### Second Embodiment

Next, a second embodiment of the present invention will be described below.

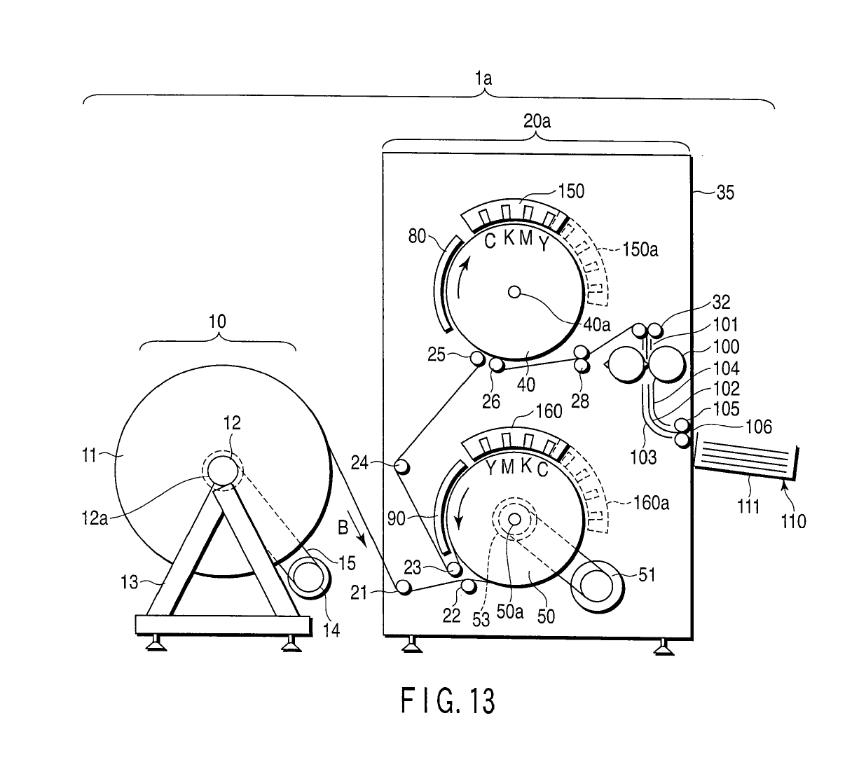

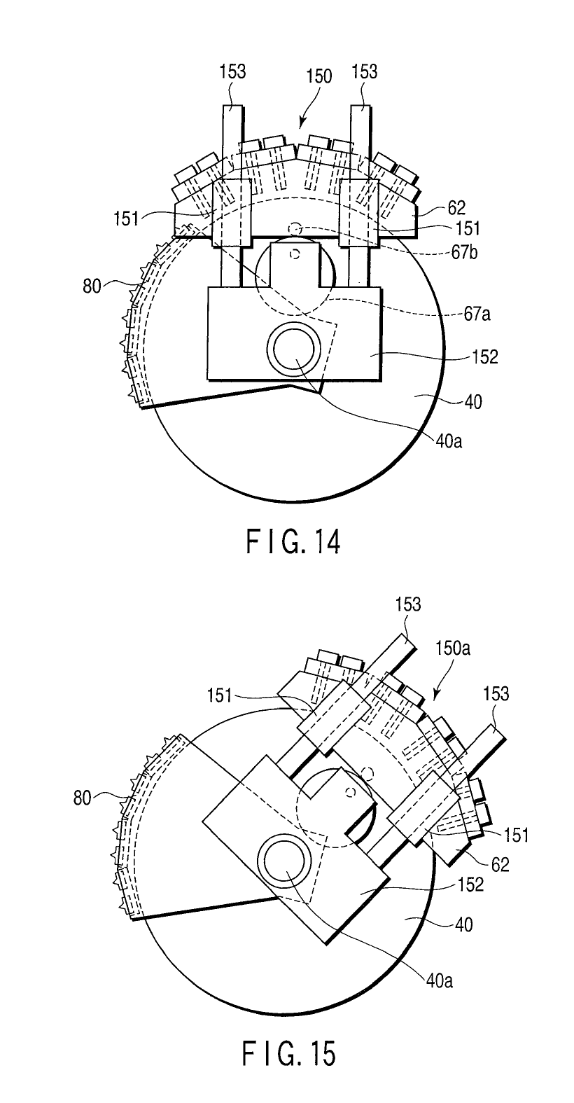

FIG. 13 is a view schematically showing a transfer system of a recording medium 11 in an image recording apparatus 1a according to the second embodiment of the present invention. FIG. 14 is a view showing the state where a first recording section 150 in the second embodiment of the present invention is in a printing position. FIG. 15 is a view showing the state where the first recording section 150 in the second embodiment of the present invention is in an inclined position (head replacement position).

Hereinafter, the second embodiment of the present invention will be described below in detail with reference to FIGS. 13 to 15.

It should be noted that regarding the image recording apparatus 1a of the second embodiment to be described below, description of parts common to the image recording apparatus 1 of each of the first embodiment, and first and second modification examples will be omitted, and a transfer path of a recording medium 11 will be described below.

The recording medium 11 brought in the main body section 20a is transferred to a second drum 50 via a transfer system constituted of a free roller 21, and free roller 22. Each of these free rollers 21 and 22 is rotatably supported by a main body frame 35. The recording medium 11 held by the second drum 50 is transferred to a position immediately under a second recording section 160 arranged in opposition to the second drum 50. Further, recording is carried out on the recording medium 11 by the second recording section 160.

The recording medium 11 on which an image has been recorded is subsequently separated from the second drum 50 by a free roller 23, and wound around a first drum 40 from a free roller 25 via a free roller 24.

When the recording medium 11 is passed through a position immediately under a first recording section 150, ink is jetted out to record an image on the recording medium 11. Hereby, two-sided recording on the recording medium 11 is completed. It should be noted that first and second cleaning sections 80 and 90 are arranged on the paper feed side with respect to the first recording section 150, and second recording section 160, respectively.

The recording medium 11 having images recorded on both the surfaces by the second recording section 160, and first recording section 150 in the manner described above is separated from an outer circumferential surface of the first drum 40, and reaches a second nip roller pair 32 via a first nip roller pair 28. Furthermore, the recording medium 11 is transferred from the second nip roller pair 32 to a cutter section 100 via an introduction guide 101. The recording medium 11 is guided to ejection guides 103 and 104 as a cut sheet cut to a predetermined length by the cutter section 100 to be accommodated in an ejection section 110.

Next, a movement mechanism for movement of the first recording section with respect to the first drum 40 in the second embodiment will be described below.

Four guide members 151 are provided on both aide surfaces of the head retaining member 62 of the first recording section 150 in the front-back direction of the apparatus. These guide members 151 are engaged with four guide shafts 153 upwardly extending in the direction of gravitational force. One end of each of the guide shafts 153 is held by a guide shaft fixing member 152. Attachment/detachment of the guide member 151 of this embodiment is not carried out to/from the guide shaft 153, and hence a linear-motion bearing such as a general linear guide bush to be circumferentially engaged with a shaft is used as the guide member 151.

The guide shaft fixing member 152 is engaged with the rotating shaft 40a of the first drum 40, and is held rotatable around the rotating shaft 40a of the first drum 40. Hereby, the first recording section 150 is held by the main body frame 35 through the guide shaft 153, guide shaft fixing member 152, and rotating shaft 40a of the first drum 40.

A movement mechanism configured to separate the first recording section 150 from the first drum 40 along the guide shafts 153 includes a cam 67a rotatably attached to the inner side of each of the guide shaft fixing members 152, and cam followers 67b attached to the head retaining member 62 of the first recording section 150. The operation of the movement mechanism is identical with the first embodiment described previously.

By means of this movement mechanism, the first recording section 150 can move, with respect to the first drum 40, to the printing position at which image recording is to be carried out, upper limit position at which the first cleaning section 80 can be inserted between the first recording section 150 and first drum 40, and cleaning position at which a cleaning operation is carried out by the first cleaning section 80.

Next, the procedure for the work of replacing the recording head in the second embodiment will be described below with reference to FIGS. 14 and 15.

First, as shown in FIG. 14, the first recording section 150 in the printing position with respect to the first drum 40 is rotated by a rotation mechanism (not shown) toward the paper ejection side on which the first cleaning section 80 is not arranged by about 45 degrees as shown in FIG. 15. That is, the rotation mechanism rotates the first recording section 150 without changing the distance between the first recording section 150 and outer circumferential surface of the first drum 40 by using the rotating shaft 40a of the first drum 40 as a point of reference. Hereby, the first recording section 150 is brought into the state of the first recording section 150a in the head replacement position. In the state of the first recording section 150a in the head replacement position, a side outer cover (not shown) on the paper ejection side of the main body section 20 is opened, and the replacement work of the recording head is carried out. At this time, as shown in FIG. 13, the first recording section 150 in the recording head replacement position is within the internal space of the main body section 20, and there is no need to draw out the first recording section 150 to the outside of the outer cover.

After the work is completed, the side outer cover (not shown) is closed, and the first recording section 150a in the recording head replacement position is moved to the first recording section 150 in the printing position.

Thereafter, a cleaning operation is carried out in order to fill the inside of the new replacement recording head with ink, then a test pattern is printed to confirm presence/absence of defective ink jetting, and image adjustment such as position adjustment of the recording head, print density adjustment, and the like is carried out, thereby completing a series of recording head replacement work.

It should be noted that in this second embodiment, although the replacement work of the recording head has been carried out by inclining the first recording section 150 to the paper ejection side, it is also possible to carry out the replacement work of the recording head by inclining the first recording section 150 to the paper feed side when the first cleaning section 80 is arranged on the paper ejection side.

As described above, in this second embodiment, there is no need to provide the main body frame with an opening through which the recording section is to be drawn out, and hence the rigidity of the main body frame is not lowered. Further, the replacement work of the recording head can be carried out only by inclining the recording section from the printing position of the recording section to the side on which the replacement work of the recording head is to be carried out, and the working process can be simplified.

### First Modification Example of Second Embodiment

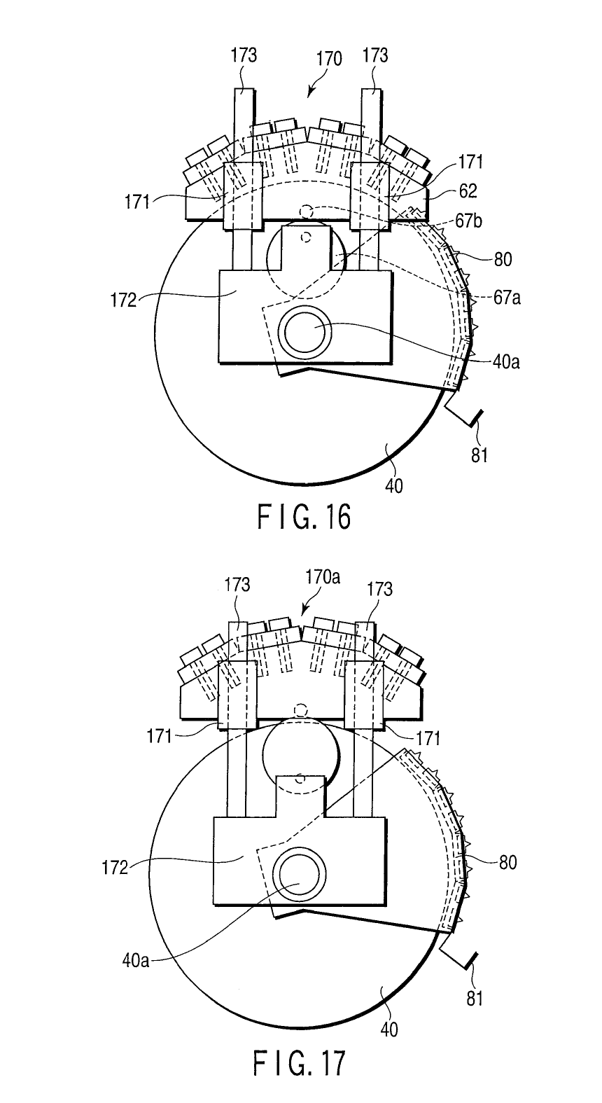

Next, a first modification example of the second embodiment of the present invention will be described below with reference to FIGS. 16 to 18.

A first cleaning section 80 is arranged on the paper ejection side with respect to a first recording section 170. An ink receiving section 81 is provided at an end part of the first cleaning section 80 on the retraction side. The ink receiving section 81 is configured to carry out a function of temporarily collecting dripping ink, and returning the collected ink, when the first cleaning section 80 is brought to the cleaning position, to an ink pan of the first cleaning section 80 main body to drain the ink into the waste fluid path.

Four guide members 171 are fixed to both side surfaces of a head retaining member 62 of the first recording section 170 in the front-back direction of the apparatus. These guide members 171 are engaged with four guide shafts 173 upwardly extending in the direction of gravitational force. One end of each of the guide shafts 173 is held by a guide shaft fixing member 172. Attachment/detachment of the guide member 171 of this embodiment is not carried out to/from the guide shaft 173, and hence a linear-motion bearing such as a general linear guide bush to be circumferentially engaged with a shaft is used as the guide member 171.

A movement mechanism configured to separate the first recording section 170 from the first drum 40 along the guide shafts 173 includes a cam 67a rotatably attached to the inner side of each of the guide shaft fixing members 172, and cam followers 67b attached to the head retaining member 62 of the first recording section 170. The operation of the movement mechanism is identical with the first embodiment described previously. By means of this movement mechanism, the first recording section 170 can move, with respect to the first drum 40, to the printing position at which image recording is to be carried out, upper limit position at which the first cleaning section 80 can be inserted between the first recording section 170 and first drum 40, and cleaning position at which a cleaning operation is carried out by the first cleaning section 80.

Next, the procedure for the work of replacing the recording head in the first modification example of the second embodiment will be described below with reference to FIGS. 16 to 18.

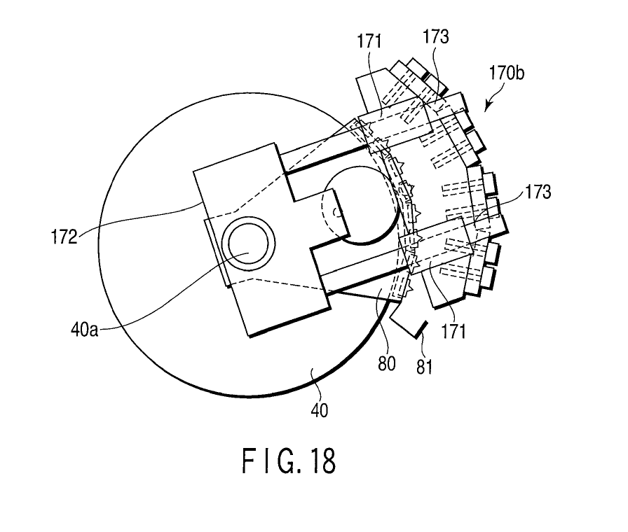

First, as shown in FIG. 16, when the first recording section 170 is in the printing position with respect to the first drum 40 as shown in FIG. 16, the apparatus is operated to move the first recording section 170 to the upper limit position as shown in FIG. 17. Subsequently, the first recording section 170a in the upper limit position with respect to the first drum 40 is rotated around the rotating shaft 40a to the paper ejection side on which the first cleaning section 80 is arranged without changing the position of the first recording section 170a in the radial direction of the first drum 40. Hereby, the first recording section 170a is brought into the state of the first recording section 170b in the recording head replacement position as shown in FIG. 18.

When the side outer cover (not shown) on the paper ejection side of the main body section 20 is opened in the state of the first recording section 170b in the recording head replacement position shown in FIG. 18, the replacement work of the recording head is carried out. At this time, the first recording section 170b in the recording head replacement position can be accommodated in the internal space of the main body section 20a as in the case of the second embodiment described previously, and it is not necessary to draw out the first recording section 170b to the outside of the outer cover.

Further, the first recording section 170b in the recording head replacement position is arranged to cover the first cleaning section 80. Hereby, even if ink drops from the recording head at the time of the replacement work of the recording head, the dropped ink is received by the ink receiving section 81 of the first cleaning section 80, and is temporarily stored therein. At the time of a cleaning operation to be carried out thereafter, the dropped ink drains into the waste fluid path.

After the replacement work of the recording head is completed, the side outer cover (not shown) is closed, and first recording section 170b in the recording head replacement position is moved to the state of the first recording section 170a in the upper limit position. Thereafter, the first recording section 170b in the recording head replacement position is moved to the state of the first recording section 170 in the printing position. Thereafter, a cleaning operation is carried out in order to fill the inside of the new replacement recording head with ink, then a test pattern is printed to confirm presence/absence of defective ink jetting, and image adjustment such as position adjustment of the recording head, print density adjustment, and the like is carried out. In this way, a series of recording head replacement work is completed.

It should be noted that in this first modification example of the second embodiment, although the replacement work of the recording head has been carried out by inclining the first recording section 170 to the paper ejection side, it is also possible to carry out the replacement work of the recording head by inclining the first recording section 170 to the paper feed side when the first cleaning section 80 is arranged on the paper ejection side.

As described above, in the first modification example of the second embodiment, it is possible to arrange the recording section to cover the cleaning section at the recording head replacement position of the recording section, and the inside of the apparatus is not soiled by ink dropping at the time of recording head replacement work.

It should be noted that in each of the embodiments described previously, the description has been given by taking the image recording apparatus including the two drums of the first and second drums as an example, the embodiments are not limited to this, and the apparatus may include one drum or a plurality of, e.g., three or more drums. Furthermore, a means other than the drum may be employed if only the means is a means to be arranged in opposition to the recording head, and is a means for holding and transferring the recording medium.

Although the embodiments of the present invention have been described above, the present invention is not limited to the above descriptions, besides the embodiments, the embodiments can be variously modified and implemented within the scope not deviating from the gist of the present invention and, in the implementation stage, the constituent elements can be modified and embodied within the scope not deviating from the gist of the invention.

Furthermore, inventions of various stages are included in the embodiments described previously, and by appropriately combining a plurality of disclosed constituent elements with each other, various inventions can be extracted. For example, some constituent elements may be deleted from all the constituent elements shown in the embodiments, furthermore, different constituent elements of the embodiments may be appropriately combined with each other, and when the problems described in the paragraph of “problems to be solved” can be solved, and the advantages described in the paragraph of “advantages of the invention” can be obtained, the configuration from which the constituent elements have been deleted can be extracted as an invention.

According to the present invention, it is possible to obtain an image recording apparatus in which replacement work can be easily carried out without lowering the rigidity of the frame when a recording head of a recording section provided with a line head constituted of a plurality of recording heads or one long recording head is to be replaced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ink-jet printer comprising:
a drum configured to transfer a recording medium by holding the recording medium on a cylindrical outer circumferential surface thereof;
a recording section arranged in opposition to the outer circumferential surface of the drum, and including a recording head configured to record an image on the recording medium; and
a main body frame configured to rotatably support both ends of a rotating shaft of the drum, wherein
when replacement work of the recording head is to be carried out, the recording section is drawn out with respect to the main body frame both in a direction perpendicular to an axial direction of the rotating shaft and in a direction perpendicular to a direction of gravitational force.

2. The ink-jet printer according to claim 1, the recording section is drawn out to the outside of the main body frame.

3. The ink-jet printer according to claim 1, further comprising a movement mechanism configured to move the recording section to a recording position close to the outer circumferential surface of the drum or a retraction position separated farther from the outer circumferential surface of the drum than the recording position, wherein
the recording section can be drawn out at only the retraction position.

4. The ink-jet printer according to claim 3, the recording section is drawn out to the outside of the main body frame.

5. The ink-jet printer according to claim 3, the recording section is supported by the main body frame at the recording position.

6. The ink-jet printer according to claim 3, the recording section is supported by the rotating shaft of the drum at the recording position.

7. The ink-jet printer according to claim 5, the recording position is a position at which the recording section is opposed to the highest position of the drum in the direction of gravitational force.

8. The ink-jet printer according to claim 6, the recording position is a position at which the recording section is opposed to the highest position of the drum in the direction of gravitational force.

9. The ink-jet printer according to claim 3, when in the recording position, the recording section is opposed to the highest position of the drum in the direction of gravitational force, and the movement mechanism moves the recording section from the recording position to the retraction position by raising the recording section.

10. The ink-jet printer according to claim 1, further comprising:
a movement mechanism configured to move the recording section to a recording position close to the outer circumferential surface of the drum or a retraction position separated farther from the outer circumferential surface of the drum than the recording position; and
a guide mechanism configured to, when the recording section is to be moved from the recording position to the retraction position by the movement mechanism, guide the recording section to a direction of movement by being engaged with the recording section, wherein
the recording section is released from the engagement with the guide mechanism at the retraction position, and can be drawn out at only the retraction position.

11. The ink-jet printer according to claim 10, when in the recording position, the recording section is opposed to the highest position of the drum in the direction of gravitational force, and the movement mechanism moves the recording section from the recording position to the retraction position by raising the recording section.

12. The ink-jet printer according to claim 1, further comprising:
a cleaning section opposed to the outer circumferential surface of the drum, arranged in the vicinity of the recording section, and configured to carry out cleaning of the recording section; and
a rotation mechanism configured to rotate the recording section to a recording position at which image recording on the recording medium is to be carried out or rotate the recording section to a retraction position different from the recording position without changing a gap between the recording section and the outer circumferential surface of the drum, wherein
the recording section can be drawn out at only the retraction position.

13. The ink-jet printer according to claim 12, the rotation mechanism rotates the recording section around the rotating shaft of the drum.

14. The ink-jet printer according to claim 13, the rotation mechanism rotates the recording section from the recording position in a direction in which the cleaning section is not arranged.

15. The ink-jet printer according to claim 14, the recording position is a position at which the recording section is opposed to the highest position of the drum in the direction of gravitational force.

16. An ink-jet printer comprising:
a feed section configured to feed a recording medium;
a first drum configured to transfer the recording medium fed from the feed section by holding the recording medium on a cylindrical outer circumferential surface thereof;
a first recording section arranged in opposition to the outer circumferential surface of the first drum, and including a recording head configured to record an image on the recording medium;
a second drum configured to transfer the recording medium by holding the recording medium on which an image has been recorded by the first recording section on a cylindrical outer circumferential surface thereof;
a second recording section arranged in opposition to the outer circumferential surface of the second drum, and including a recording head configured to record an image on the recording medium; and
a main body frame configured to rotatably support both ends of a rotating shaft of each of the first drum and the second drum, wherein
each of the first recording section, and the second recording section can be drawn out with respect to the main body frame both in a direction perpendicular to an axial direction of corresponding one of the rotating shafts and in a direction perpendicular to a direction of gravitational force.

17. The ink-jet printer according to claim 16, the first recording section, and the second recording section are drawn out to the outside of the main body frame.

18. The ink-jet printer according to claim 17, the first drum and the second drum are arranged in such a manner that at least part of each of the first drum and the second drum overlap each other in the direction of gravitational force.

19. The ink-jet printer according to claim 18, the feed section feeds rolled paper as the recording medium.
